(19) United States
(12) Patent Application Publication
(10) Pub. No.: US 2011/0214748 A1
(43) Pub. Date: Sep. 8, 2011

(54) Systems and Methods for Purging a Valve in a Liquid Flow Line

(76) Inventor: Kurt Sebben, San Jose, CA (US)

(21) Appl. No.: 12/718,797

(22) Filed: Mar. 5, 2010

(51) Int. Cl. B08B 3/04; F16K 5/08

(52) U.S. Cl. 137/15.06; 251/304; 137/237

(57) ABSTRACT

A ball valve with a purging mechanism is used in a method that provides a fluid purge of the valve. The fluid purge may be accomplished by introducing fluid into a housing of the valve and allowing the fluid to pass through the valve and out through an outlet port. The fluid purge eliminates any residual matter from a liquid flow line. The fluid used for the purge is typically nitrogen or clean dry air (CDA).

### CROSS-REFERENCE TO RELATED APPLICATIONS

This application is related to U.S. patent application Ser. No. ______, filed Mar. 5, 2010, the disclosure of which is incorporated herein by reference.

### BACKGROUND OF THE INVENTION

1. Field of the Invention

The present invention generally relates to liquid handling equipment. The invention more particularly relates to systems and methods for purging a valve in a liquid flow line to remove unwanted residual matter.

2. Description of the Related Art

Many chemical mixing processes involve mixing a liquid, often water, with a crystalline or dry powdered chemical to form a solution. In such processes, it is often important to minimize dead spots in the plumbing that carries the water to be used in the mixture. Dead spots in the plumbing are often detrimental to mixing processes.

When a liquid used in a mixing process is water or any other liquid capable of sustaining bacterial life, the growth of bacteria in dead spots in a plumbing system provides a prime source of contamination for the mixing process. Present bacteria in the dead spots can contaminate the mixture, which can potentially ruin a solution batch if the contamination is not discovered before the initiation of the mixing process.

The presence of water in dead spots can also degrade the accuracy of the resultant product of the mixing process. Liquid trapped in dead spots cannot be accounted for when measuring the solution components to be mixed. Therefore the amount of liquid being added to a dry chemical may be more or less than that which was measured by the operator. The composition of the resultant product of the process changes as a result if the change in measurement and may result in an usuable mixture.

In order to minimize dead spots in a line, liquid handling systems often utilize ball valves. A ball valve is operated by rotating a handle plus or minus ninety degrees to open or close, respectively, a supply line in which the valve is installed. When the valve is in either a fully open or fully closed position, the body of the valve completely fills the line, so that no water can accumulate outside the flow path of the line. Movement of the ball valve between the open and closed positions may, however, expose dead spots around a rotatable main body of the ball valve. Such dead spots can trap liquid and degrade the accuracy of the system in which the valve is installed as described above.

There is, therefore, a need in the art for a valve that includes a mechanism for purging a valve utilized in a liquid flow line.

### SUMMARY OF THE CLAIMED INVENTION

The present invention includes systems, methods, and an apparatus for purging a liquid flow line of unwanted residual matter. For ease of description and illustration, the technology will be described with reference to a ball valve. Those skilled in the art and having reviewed the present specification will recognize that many different types of valves could be successfully employed in practice of the present invention.

In one claimed embodiment, the valve apparatus includes a housing with a rotatable main body movable between a first position in which a throughway in the main body aligns with a liquid flow line in which the valve is installed, and a second position in which the main body blocks the liquid flow line. The valve also includes a handle that moves the main body between the first position and the second position. The valve further includes a purge inlet port and a purge outlet port. The purge inlet port and the purge outlet port are in fluid communication with an interior of the valve housing. The purge inlet port and the purge outlet port define ends of a fluid flow path through the interior of the housing.

An exemplary method utilizing the valve includes selecting an appropriate valve and installing the valve in the liquid flow line. Following operation, in order to purge the valve of any unwanted material, a fluid may be introduced into the purge inlet port. The fluid will typically be under pressure, and may be either a gas or a liquid. The fluid flows through the purge inlet port into an interior of a valve housing, and then out through a purge outlet port, thereby removing residual matter from an interior of the valve.

### BRIEF DESCRIPTION OF THE DRAWINGS

FIG. 1 is a sectional view of a ball valve including a purge mechanism in a fully open position in a liquid flow line.

FIG. 2 is a sectional view of the ball valve of FIG. 1 in a fully closed position.

FIG. 3 is a sectional view of the ball valve of FIG. 1 in a transitional position between the open position and the closed position.

FIG. 4 is a flowchart illustrating a method for purging a valve in a liquid flow line.

### DETAILED DESCRIPTION

Exemplary embodiments of the present invention include a valve with a purging mechanism. The purging mechanism eliminates residual matter from an interior of the valve. Eliminating residual matter may improve the performance of the valve as well as performance of a system in which the valve is utilized.

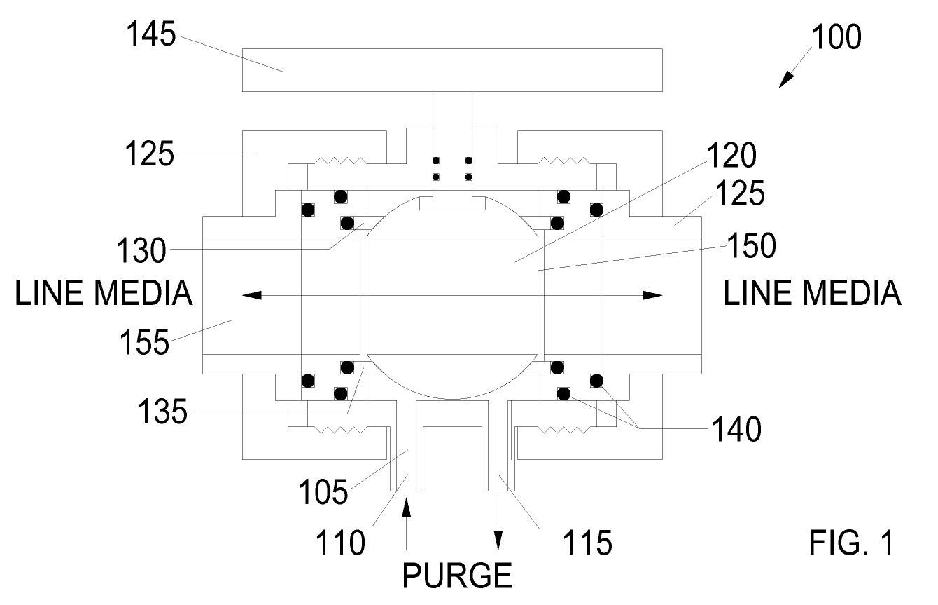

FIG. 1 depicts a valve 100 in a fully open position. The valve 100 may be utilized in a liquid flow line to control the flow rate of a line media, typically a liquid or an aqueous solution. The valve 100 of FIG. 1 includes a purge mechanism 105 that includes an inlet port 110 and an outlet port 115. The purge mechanism 105 illustrated in FIG. 1 accommodates gases and liquids as the purging medium.

Many types of valves may be used with reference to the teachings of valve 100. For purposes of the present disclosure, a ball valve is described and illustrated. The ball valve 100 shown in FIG. 1 includes a rotatable main body 120 contained in a housing 125. The rotatable main body 120 may be secured in position in the housing 125 through the use of an upper positioning disk 130 and a lower positioning disk 135. The positioning disks 130, 135 may be secured in slots in the housing 125.

The housing 125 may be constructed as a single molded unit or from multiple components. The components may be joined by threaded couplings, by welding, or by other manufacturing methods. Joints between the multiple components of the housing 125 may be sealed with O-rings 140 to prevent leakage.

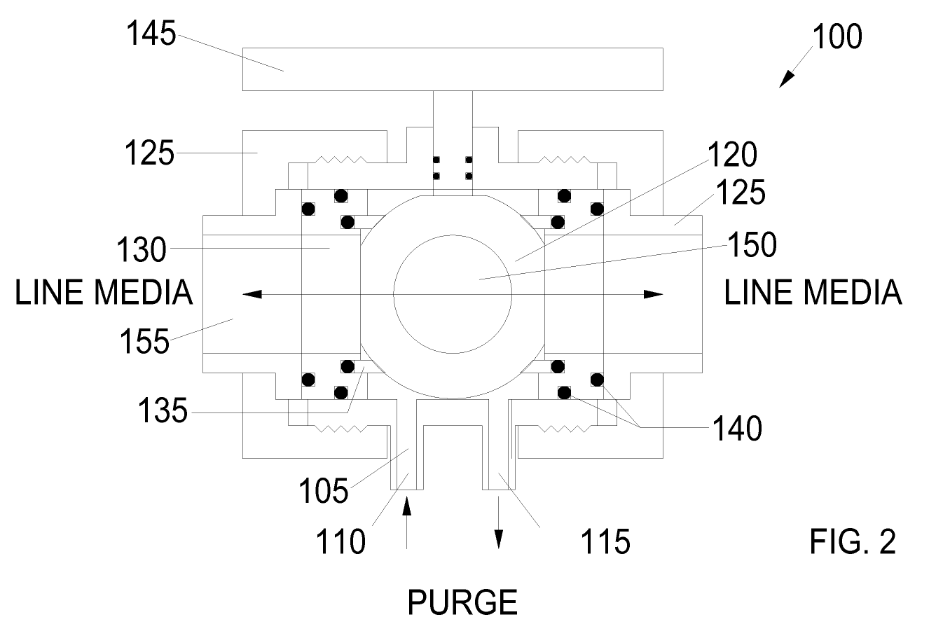

An actuating handle 145 is provided in FIG. 1 for operation of the ball valve 100. The actuating handle 145 is configured to move the rotatable body 120 of the valve 100 from a first position (the open position shown in FIG. 1), through an approximately ninety degree arc to a second position (the closed position shown in FIG. 2).

Referring again to FIG. 1, when the valve 100 is in the open position, a central throughway 150 in the rotatable main body 120 is aligned with a liquid flow line 155. The central throughway 150 has a diameter approximately equal to that of the liquid flow line 155 in which the valve 100 is deployed. Since the central throughway 150 has substantially the same cross-sectional area as that of the liquid flow line 155, there are few or no dead spots around the rotatable main body 120 of the valve 100 in which unwanted residual liquid can accumulate. Similarly, when the valve 100 is in the closed position as depicted in FIG. 2, the solid portion of the rotatable main body 120 of the valve 100 effectively seals the liquid flow line 155 so that no accumulation of residual liquid can occur.

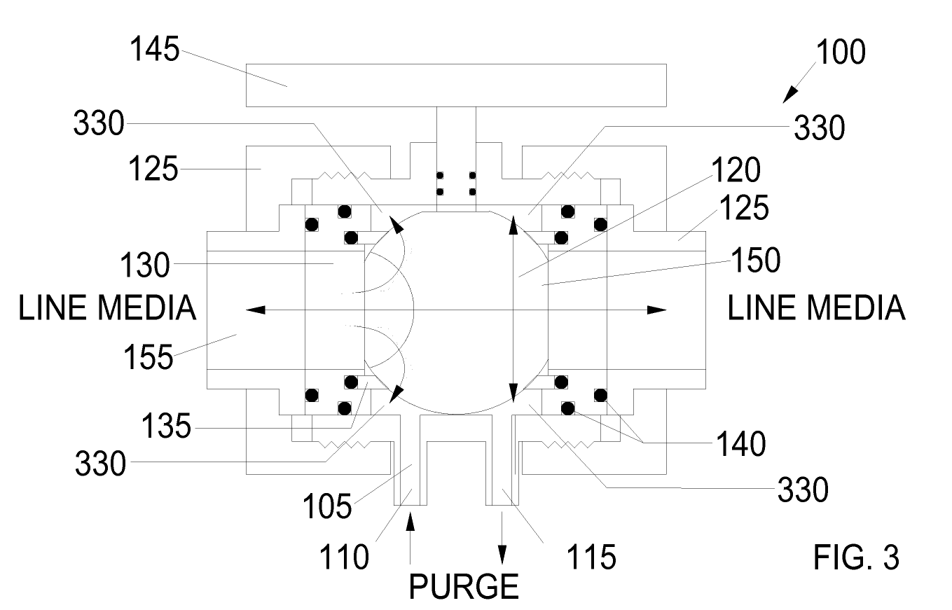

The problem of accumulating residual water arises when the valve 100 is in a transition position illustrated in FIG. 3. The transition position is between the open and closed positions, which are shown in FIGS. 1 and 2, respectively. When the valve is in transition between the open and closed positions, the rotatable main body 120 of the valve 100 is in the transition position illustrated in FIG. 3. When the rotatable main body 120 is in the transition position, the valve 100 cannot effectively seal the flow line 155. Thus when the valve 100 is in transition between the open and closed positions, liquid may be free to flow “around the edges” of the rotatable main body 120 into dead spots 330.

Once liquid is trapped in the dead spots 330, the liquid may not be readily evacuated from the valve 100 unless the liquid is acted upon by an outside force. Moreover, depending on the application in which the valve 100 is being utilized, the liquid in the dead spots 330 may include some dry chemical in solution. The residual solution may become gummy as it dries, thereby inhibiting free operation of the valve 100. The ability to eliminate the residual matter may therefore greatly enhance the operation of the valve 100.

In some processes in which the valve 100 may be deployed, residual matter may be a critical flaw. One such process is described in co-pending U.S. patent application Ser. No. ______, filed on Mar. 5, 2010, and has been previously incorporated herein.

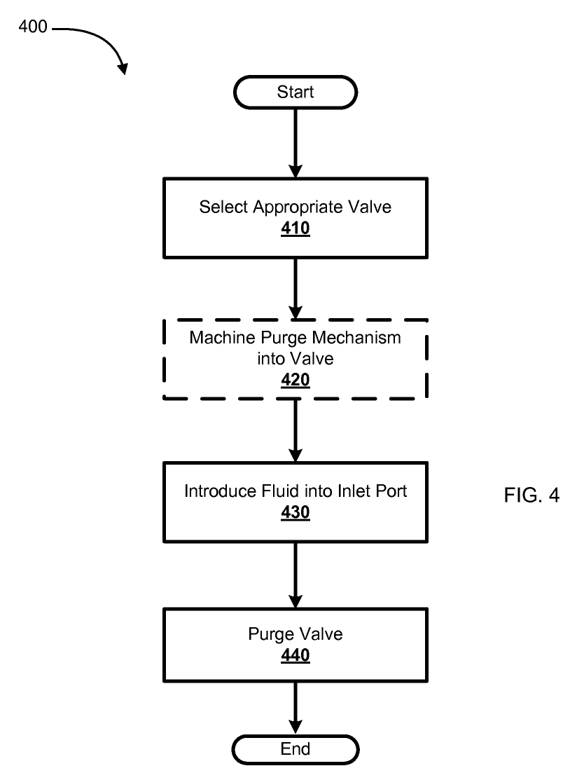

In order to eliminate the problem of residual matter in the dead spots 330 (FIG. 3) of the valve 100 (FIGS. 1-3), an exemplary fluid purging process 400 is utilized as outlined in FIG. 4. An initial step 410 of the process 400 is to select an appropriate valve for a subject liquid flow line. It should be noted that a purge mechanism 105 for the valve 100 may be included in the original manufacture of the valve 100. In valves not manufactured with a purge mechanism 105, a next step is to machine a purge mechanism into the valve as indicated in optional step 420 and as shown in the method of FIG. 4. In the optional machining step 420, a purge inlet port 110 and a purge outlet port 115 may be machined into the housing 125 of the valve 100. The inlet 110 and outlet 115 ports are machined so as to be in fluid communication with the interior of the housing 125, and in particular the dead spots 330 surrounding the rotatable main body of the valve 100.

The valve 100 is installed in the liquid flow line 155, and the flow line is operated. Following operation of the flow line, a purging fluid is introduced into the purge inlet port 110 in a step 430. The purging fluid will typically be under pressure.

The purging fluid flows through purge inlet port 110 and into the dead spots 330. As the purging fluid flows through the purge mechanism 105, the purging fluid displaces residual matter remaining in the purging flow path. The purging fluid then exits the housing 125 by flowing out of the outlet port 115 in a step 440, thereby completing the evacuation of the residual matter from the valve 100.

The purge outlet port 115 may be in fluid communication with an end product collection vessel to ensure that all material introduced into the liquid flow line is included with the end product.

In an exemplary embodiment, the purging fluid is nitrogen. Clean dry air (CDA) or de-ionized water may also be used as the purging fluid depending on the specific application. Those skilled in the art will recognize that other fluids may be chosen as the purging fluid.

The embodiments described herein are illustrative of the present invention. As these embodiments of the present invention are described with reference to illustrations, various modifications or adaptations of the methods and or specific structures described may become apparent to those skilled in the art in light of the descriptions and illustrations herein. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A valve comprising:
a housing;
a main body enclosed in the housing, and movable between a first position in which a throughway in the main body aligns with a liquid flow line in which the valve is installed, and a second position in which the main body blocks the liquid flow line;
a handle that moves the main body between the first position and the second position;
a purge inlet port; and
a purge outlet port, the purge inlet port and the purge outlet port being in fluid communication with an interior of the housing.

2. The valve of claim 1, wherein a purge inlet port and a purge outlet port define ends of a fluid flow path through the interior of the housing.

3. The valve of claim 1, wherein the main body is rotatable.

4. The valve of claim 3, wherein the rotatable body includes a central throughway with a diameter equal to a diameter of the liquid flow line.

5. A system for purging a valve in a liquid flow line, the system comprising:
a valve that controls a flow rate through the liquid flow line;
a purge inlet port; and
a purge outlet port, wherein during a purging operation, a fluid is introduced into the purge inlet port, the fluid flowing through an interior of the valve and out through the purge outlet port to remove residual matter from the interior of the valve.

6. The system of claim 5, wherein the purge inlet port introduces a fluid under pressure.

7. The system of claim 5, wherein the purging operation utilizes a gas.

8. The system of claim 5, wherein the purging operation utilizes a liquid.

9. The system of claim 5, wherein the purging operation utilizes nitrogen.

10. The system of claim 5, wherein the purging operation utilizes clean dry air.

11. The system of claim 5, wherein the purging operation utilizes de-ionized water.

12. The system of claim 5, further comprising placing the purge outlet port in fluid communication with an end product collection vessel to ensure that all material introduced into the liquid flow line is included in an end product

13. The system of claim 5, further comprising machining the purge inlet port and the purge outlet port into a housing of the valve.

14. The system of claim 5, further comprising molding the purge inlet port and the purge outlet port into a housing of the valve.

15. A method for purging a valve in a liquid flow line, the method comprising:
selecting a valve and installing the valve in the liquid flow line;
operating the liquid flow line; and
introducing a fluid into a purge inlet port, the fluid flowing through the purge inlet port into an interior of a valve housing, the fluid then flowing out through a purge outlet port, thereby removing residual matter from an interior of the valve.

16. The method of claim 15, further comprising machining the purge inlet port and the purge outlet port into a valve housing.

17. The method of claim 15, wherein introducing a fluid into the purge inlet port includes introducing the fluid under pressure.

18. The method of claim 15, wherein introducing a fluid into the purge inlet port includes introducing a gas.

19. The method of claim 15, wherein introducing a fluid into the purge inlet port includes introducing a liquid.

20. The method of claim 15, further comprising placing the outlet purge port in fluid communication with an end product collection vessel to ensure that all material introduced into the liquid flow line is included with the end product.
